(19) United States
(12) Patent Application Publication
(10) Pub. No.: US 2003/0023830 A1
(43) Pub. Date: Jan. 30, 2003

(54) Method and system for encoding instructions for a VLIW that reduces instruction memory requirements

(76) Inventor: Eugene B. Hogenauer, San Carlos, CA (US)

Correspondence Address: Joseph A. Sawyer, Jr., SAWYER LAW GROUP LLP, P.O. Box 51418, Palo Alto, CA, 94303, US

(21) Appl. No.: 09/916,142

(22) Filed: Jul. 25, 2001

(51) Int. Cl. G06F 15/00

(52) U.S. Cl. 712/24

(57) ABSTRACT

Aspects of a method and system for encoding instructions as a very long instruction word for processing in a plurality of computation units that reduces instruction memory requirements in a processing system are described. The aspects include determining at which stages of instruction processing that an instruction code needs to be executed. Further, an enable signal of the instruction code is utilized to direct execution during the determined stages by controlling storage operations for the instruction code.

### FIELD OF THE INVENTION

The present invention relates to very long instruction words (VLIWs) and more particularly to instruction encoding for a VLIW in a manner that reduces instruction memory requirements.

### BACKGROUND OF THE INVENTION

The electronics industry has become increasingly driven to meet the demands of high-volume consumer applications, which comprise a majority of the embedded systems market. Embedded systems face challenges in producing performance with minimal delay, minimal power consumption, and at minimal cost. As the numbers and types of consumer applications where embedded systems are employed increases, these challenges become even more pressing. Examples of consumer applications where embedded systems are employed include handheld devices, such as cell phones, personal digital assistants (PDAs), global positioning system (GPS) receivers, digital cameras, etc. By their nature, these devices are required to be small, low-power, light-weight, and feature-rich.

In the challenge of providing feature-rich performance, the ability to produce efficient utilization of the hardware resources available in the devices becomes paramount. As in most every processing environment that employs multiple processing elements, whether these elements take the form of processors, memory, register files, etc., of particular concern is finding useful work for each element available for the task at hand.

In attempting to improve performance, a scheme involving a very long instruction word (VLIW) has gained attention. As is conventionally understood, in the VLIW scheme, a long instruction containing a plurality of instruction fields is used, and each instruction field controls a processing unit such as a calculation unit and a memory unit. One instruction can therefore control a plurality of processing units. In order to simplify an instruction issuing circuit, each instruction field of a VLIW instruction is assigned a particular operation or instruction. With the VLIW scheme, in compiling a VLIW instruction, the dependency relationship between particular instructions of a program is taken into consideration to schedule the execution order of the instructions and distribute them into a plurality of VLIW instructions so as to make each VLIW instruction contain concurrently as many as possible executable small programs. As a result, a number of small instructions in each VLIW instruction can be executed in parallel and the execution of such instructions does not require a complicated instruction issuing circuit. This, in turn, aids the ability to shorten the machine cycle period, to increase the number of instructions issued at the same time, and to reduce the number of cycles per instruction (CPI).

Since in the VLIW scheme, each VLIW instruction contains instruction fields corresponding to processing units, if there is a processing unit not used by a VLIW instruction, the instruction field corresponding to this processing unit is assigned a NOP (no operation) instruction indicating no operation. Depending on the kind of a program, a number of NOP instructions are embedded in a number of VLIW instructions. As NOP instructions are embedded in a number of instruction fields of VLIW instructions, the number of VLIW instructions constituting the program increases. Therefore, the storage requirements increase for storing a large capacity of these VLIW instructions.

Such increases in memory requirements are counterintuitive to the size restrictions placed on handheld-type devices. Accordingly, a need exists for encoding VLIW instructions that reduces instruction memory requirements. The present invention addresses such a need.

### SUMMARY OF THE INVENTION

Aspects of a method and system for encoding instructions as a very long instruction word for processing in a plurality of computation units that reduces instruction memory requirements in a processing system are described. The aspects include determining at which stages of instruction processing that an instruction code needs to be executed. Further, an enable signal of the instruction code is utilized to direct execution during the determined stages by controlling storage operations for the instruction code.

Through the present invention, a straightforward technique of using a combination of action and enable signals for instructions allows instruction fields within a VLIW to be collapsed. Thus, less memory is required to store instructions. These and other advantages will become readily apparent from the following detailed description and accompanying drawings.

### BRIEF DESCRIPTION OF THE DRAWINGS

FIG. 1 is a block diagram illustrating an adaptive computing engine.

FIG. 2 is a block diagram illustrating a reconfigurable matrix, a plurality of computation units, and a plurality of computational elements of the adaptive computing engine.

FIGS. 3a, 3b, 3c, 3d, 3e, 3f, 3g, 3h, and 3i illustrate diagrams related to an example of the encoding of instructions that finds application in the adaptive computing enine in accordance with a preferred embodiment of the present invention.

FIG. 4 illustrates a diagram of a dataflow graph representation.

### DETAILED DESCRIPTION OF THE INVENTION

The present invention relates to an instruction encoding scheme for VLIWs that reduces instruction memory requirements. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention utilizes an encoding technique for instruction codes in a VLIW that reduces the instruction memory requirements through the use of an enable signal and action signal for each instruction. In a preferred embodiment, the aspects of the present invention are provided in the context of an adaptable computing engine in accordance with the description in co-pending U.S. patent application Ser. No. ______, entitled “Adaptive Integrated Circuitry with Heterogeneous and Recofigurable Matrices of Diverse and Adaptive Computational Units Having Fixed, Application Specific Computational Elements,” assigned to the assignee of the present invention and incorporated by reference in its entirety herein. Portions of that description are reproduced hereinbelow for clarity of presentation of the aspects of the present invention. It should be appreciated that although the aspects are described with particular reference and with particular applicability to the adaptable computing engine environment, this is meant as illustrative and not restrictive of a preferred embodiment.

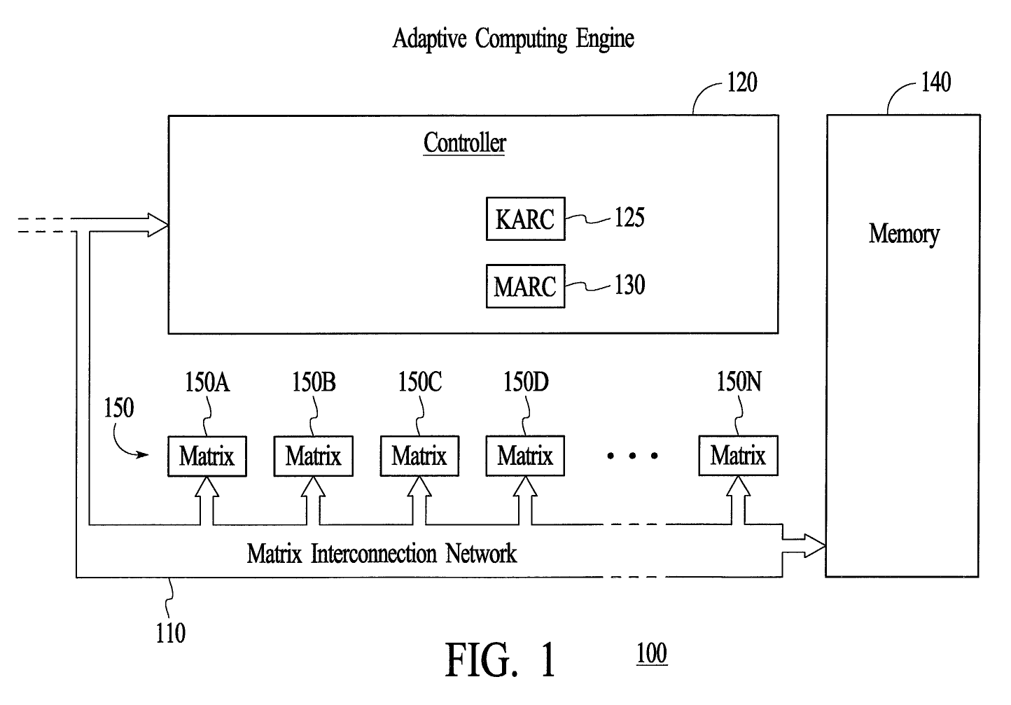

Referring to FIG. 1, a block diagram illustrates an adaptive computing engine (“ACE”) 100, which is preferably embodied as an integrated circuit, or as a portion of an integrated circuit having other, additional components. In the preferred embodiment, and as discussed in greater detail below, the ACE 100 includes a controller 120, one or more reconfigurable matrices 150, such as matrices 150A through 150N as illustrated, a matrix interconnection network 110, and preferably also includes a memory 140.

A significant departure from the prior art, the ACE 100 does not utilize traditional (and typically separate) data and instruction busses for signaling and other transmission between and among the reconfigurable matrices 150, the controller 120, and the memory 140, or for other input/output (“I/O”) functionality. Rather, data, control and configuration information are transmitted between and among these elements, utilizing the matrix interconnection network 110, which may be configured and reconfigured, in real-time, to provide any given connection between and among the reconfigurable matrices 150, the controller 120 and the memory 140, as discussed in greater detail below.

The memory 140 may be implemented in any desired or preferred way as known in the art, and may be included within the ACE 100 or incorporated within another IC or portion of an IC. In the preferred embodiment, the memory 140 is included within the ACE 100, and preferably is a low power consumption random access memory (RAM), but also may be any other form of memory, such as flash, DRAM, SRAM, MRAM, ROM, EPROM or E²PROM. In the preferred embodiment, the memory 140 preferably includes direct memory access (DMA) engines, not separately illustrated.

The controller 120 is preferably implemented as a reduced instruction set (“RISC”) processor, controller or other device or IC capable of performing the two types of functionality. The first control functionality, referred to as “kernal” control, is illustrated as kernal controller (“KARC”) 125, and the second control functionality, referred to as “matrix” control, is illustrated as matrix controller (“MARC”) 130.

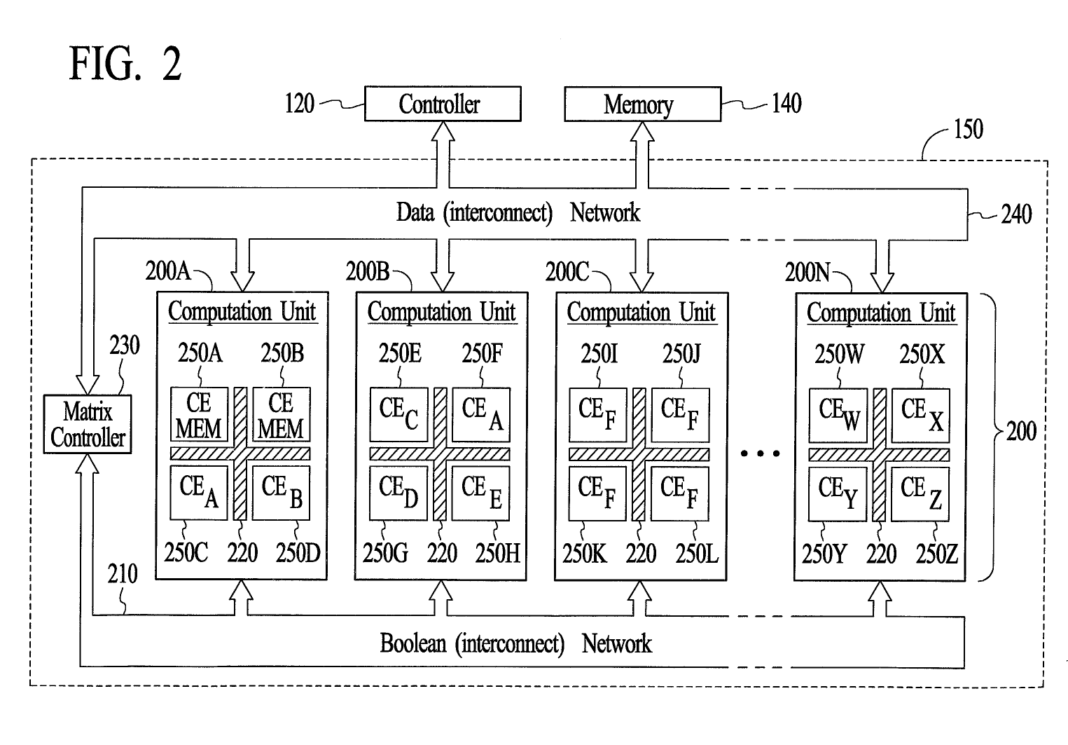

The various matrices 150 are reconfigurable and heterogeneous, namely, in general, and depending upon the desired configuration: reconfigurable matrix 150A is generally different from reconfigurable matrices 150B through 150N; reconfigurable matrix 150B is generally different from reconfigurable matrices 150A and 150C through 150N; reconfigurable matrix 150C is generally different from reconfigurable matrices 150A, 150B and 150D through 150N, and so on. The various reconfigurable matrices 150 each generally contain a different or varied mix of computation units (200, FIG. 2), which in turn generally contain a different or varied mix of fixed, application specific computational elements (250, FIG. 2), which may be connected, configured and reconfigured in various ways to perform varied functions, through the interconnection networks. In addition to varied internal configurations and reconfigurations, the various matrices 150 may be connected, configured and reconfigured at a higher level, with respect to each of the other matrices 150, through the matrix interconnection network 110.

Referring now to FIG. 2, a block diagram illustrates, in greater detail, a reconfigurable matrix 150 with a plurality of computation units 200 (illustrated as computation units 200A through 200N), and a plurality of computational elements 250 (illustrated as computational elements 250A through 250Z), and provides additional illustration of the preferred types of computational elements 250. As illustrated in FIG. 2, any matrix 150 generally includes a matrix controller 230, a plurality of computation (or computational) units 200, and as logical or conceptual subsets or portions of the matrix interconnect network 110, a data interconnect network 240 and a Boolean interconnect network 210. The Boolean interconnect network 210, as mentioned above, provides the reconfigurable interconnection capability for Boolean or logical input and output between and among the various computation units 200, while the data interconnect network 240 provides the reconfigurable interconnection capability for data input and output between and among the various computation units 200. It should be noted, however, that while conceptually divided into Boolean and data capabilities, any given physical portion of the matrix interconnection network 110, at any given time, may be operating as either the Boolean interconnect network 210, the data interconnect network 240, the lowest level interconnect 220 (between and among the various computational elements 250), or other input, output, or connection functionality.

Continuing to refer to FIG. 2, included within a computation unit 200 are a plurality of computational elements 250, illustrated as computational elements 250A through 250Z (collectively referred to as computational elements 250), and additional interconnect 220. The interconnect 220 provides the reconfigurable interconnection capability and input/output paths between and among the various computational elements 250. As indicated above, each of the various computational elements 250 consist of dedicated, application specific hardware designed to perform a given task or range of tasks, resulting in a plurality of different, fixed computational elements 250. The fixed computational elements 250 may be reconfigurably connected together to execute an algorithm or other function, at any given time, utilizing the interconnect 220, the Boolean network 210, and the matrix interconnection network 110.

In the preferred embodiment, the various computational elements 250 are designed and grouped together, into the various reconfigurable computation units 200. In addition to computational elements 250 which are designed to execute a particular algorithm or function, such as multiplication, other types of computational elements 250 may also be utilized. As illustrated in FIG. 2, computational elements 250A and 250B implement memory, to provide local memory elements for any given calculation or processing function (compared to the more “remote” memory 140). In addition, computational elements 2501, 250J, 250K and 250L are configured (using, for example, a plurality of flip-flops) to implement finite state machines, to provide local processing capability (compared to the more “remote” MARC 130), especially suitable for complicated control processing.

In the preferred embodiment, a matrix controller 230 is also included within any given matrix 150, to provide greater locality of reference and control of any reconfiguration processes and any corresponding data manipulations. For example, once a reconfiguration of computational elements 250 has occurred within any given computation unit 200, the matrix controller 230 may direct that that particular instantiation (or configuration) remain intact for a certain period of time to, for example, continue repetitive data processing for a given application.

With the various types of different computational elements 250 which may be available, depending upon the desired functionality of the ACE 100, the computation units 200 may be loosely categorized. A first category of computation units 200 includes computational elements 250 performing linear operations, such as multiplication, addition, finite impulse response filtering, and so on. A second category of computation units 200 includes computational elements 250 performing non-linear operations, such as discrete cosine transformation, trigonometric calculations, and complex multiplications. A third type of computation unit 200 implements a finite state machine, such as computation unit 200C as illustrated in FIG. 2, particularly useful for complicated control sequences, dynamic scheduling, and input/output management, while a fourth type may implement memory and memory management, such as computation unit 200A. Lastly, a fifth type of computation unit 200 may be included to perform bit-level manipulation, such as channel coding.

Producing optimal performance from these computation units involves many considerations. The present invention utilizes an encoding technique for instruction codes for a VLIW that reduces the instruction memory requirements through the use of an enable signal and corresponding action signals for each instruction in order to help improve performance.

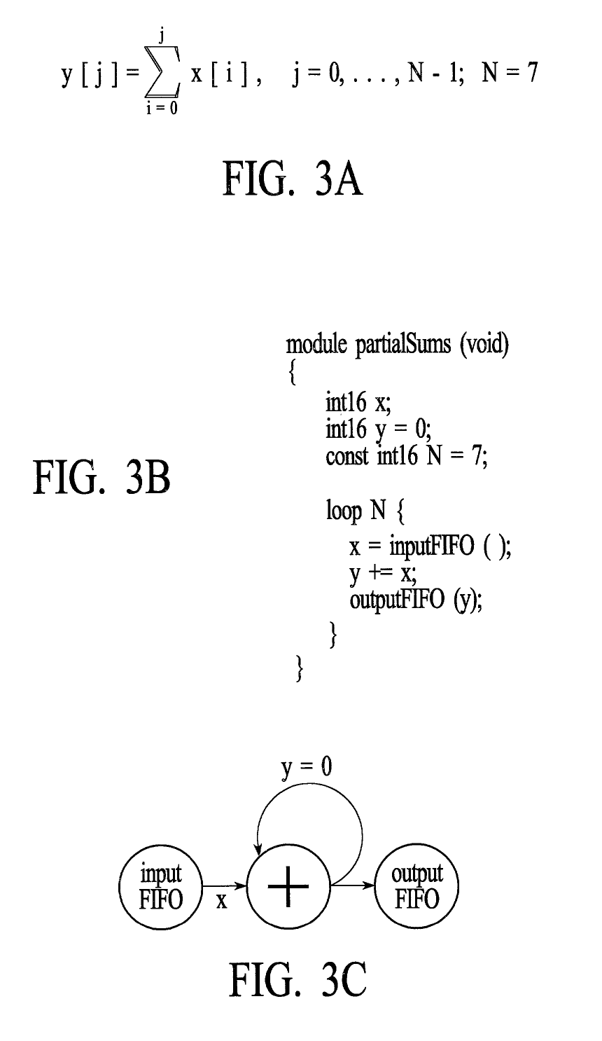

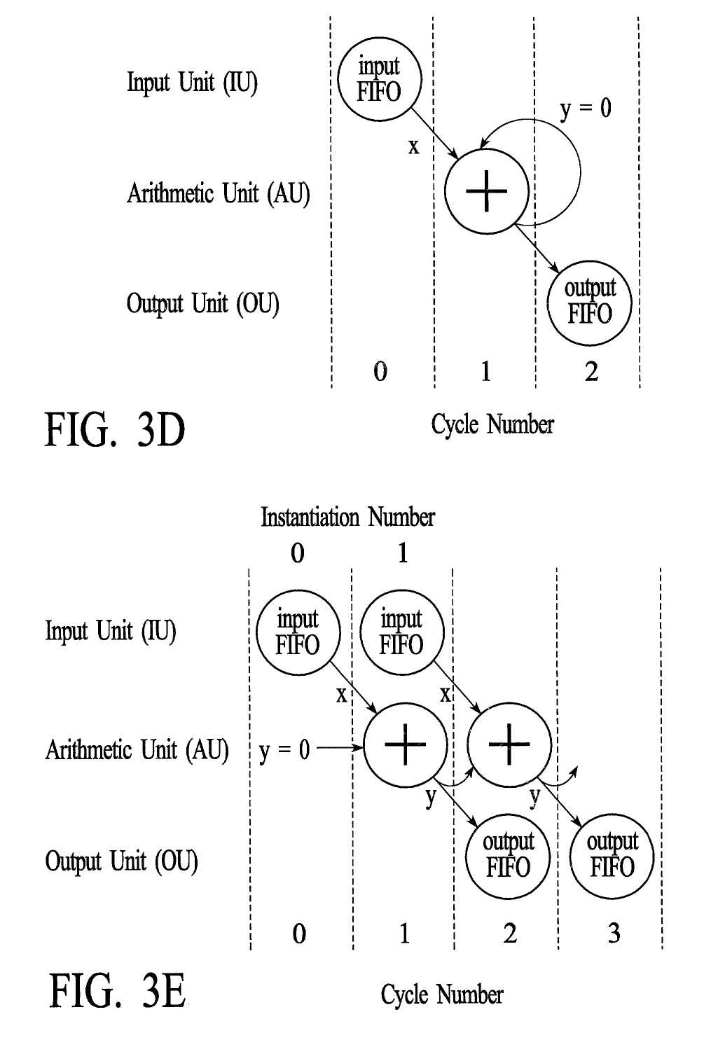

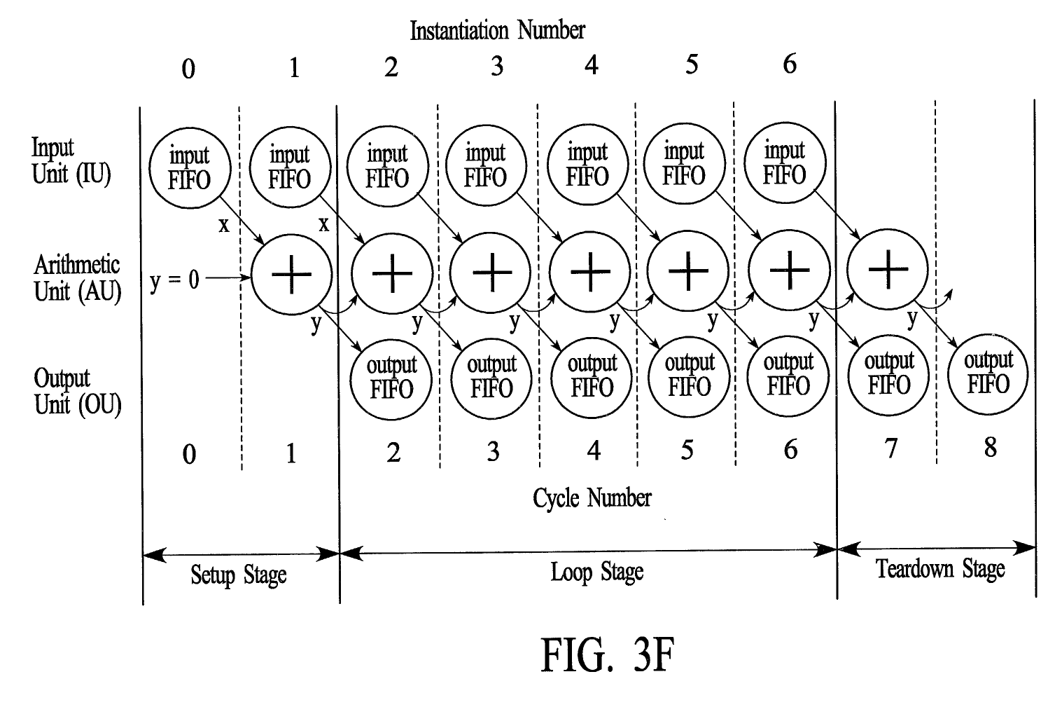

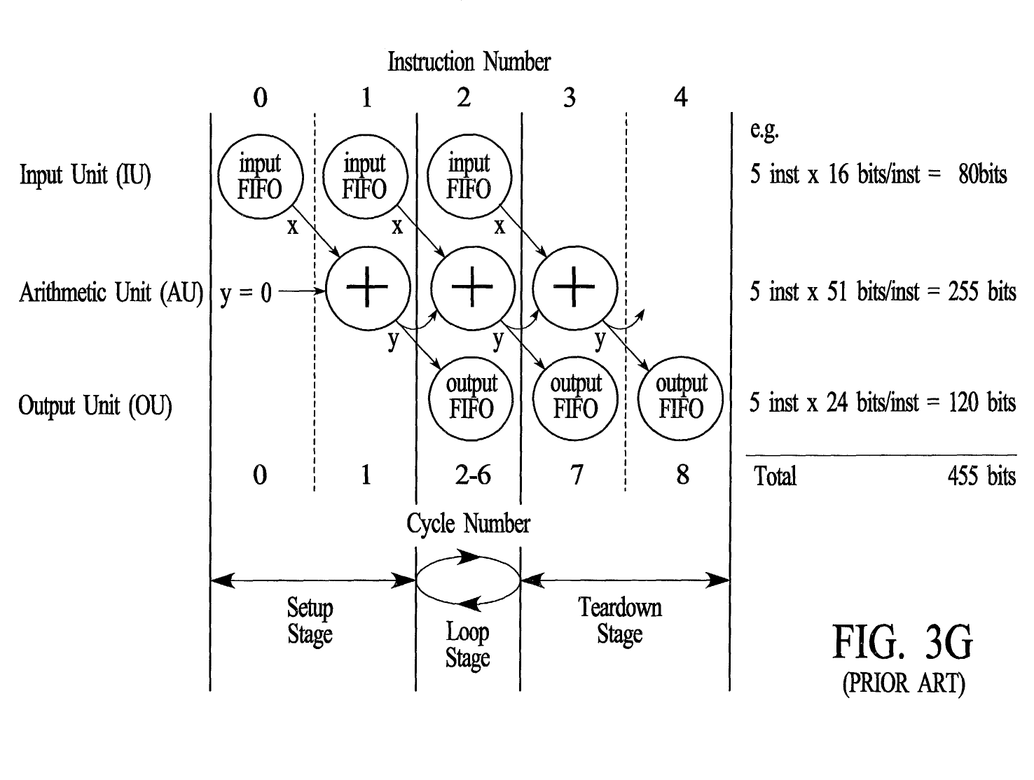

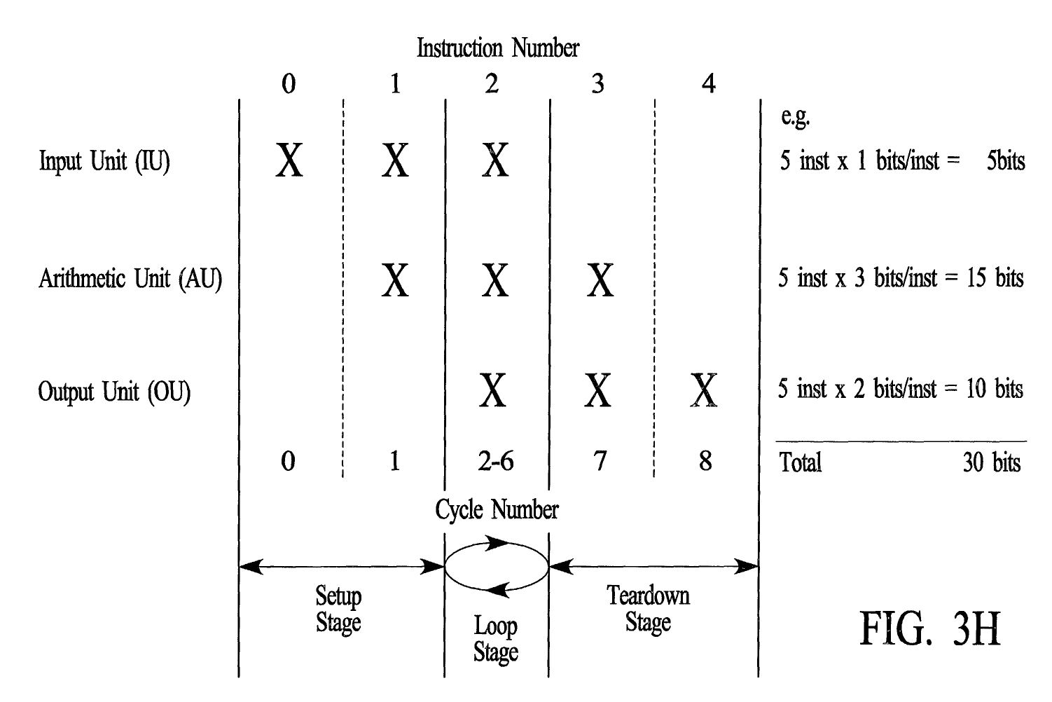

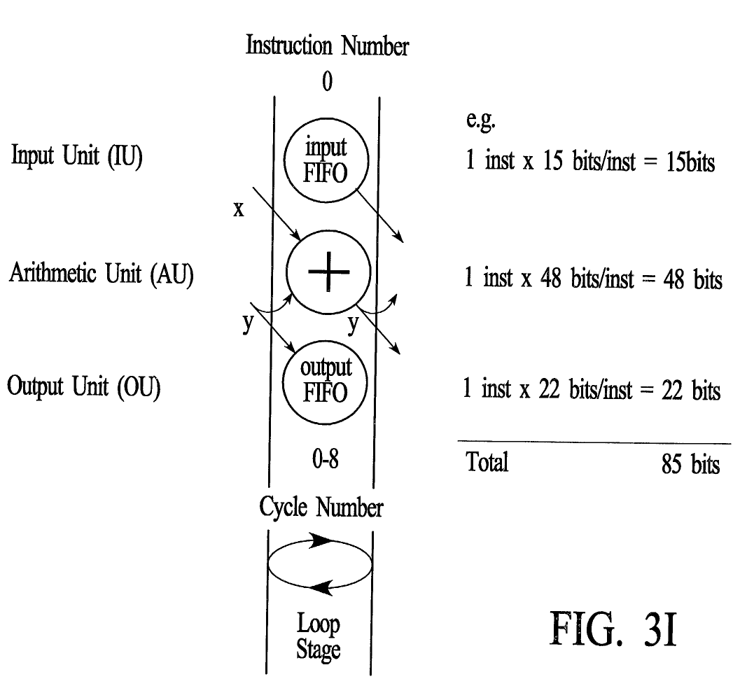

Referring, then, to FIG. 3a, as an initial step in the processing of an algorithm into instruction code, the algorithm is defined mathematically. In the example shown, a value, x[i], is summed over the range i=0 to j, where j ranges from 0 to N−1, and N=7, to produce an output value y[j]. Once defined, the algorithm is written as a program in a programming language appropriate for the computation unit, which for the ACE is preferably the Q programming language. The Q programming language is presented in more detail in copending U.S. patent application Ser. No. ______ [Docket No. QST-009-US], filed ______, entitled Q Programming Language, and assigned to the assignee of the present invention. FIG. 3b illustrates a Q program for the example algorithm shown in FIG. 3a.

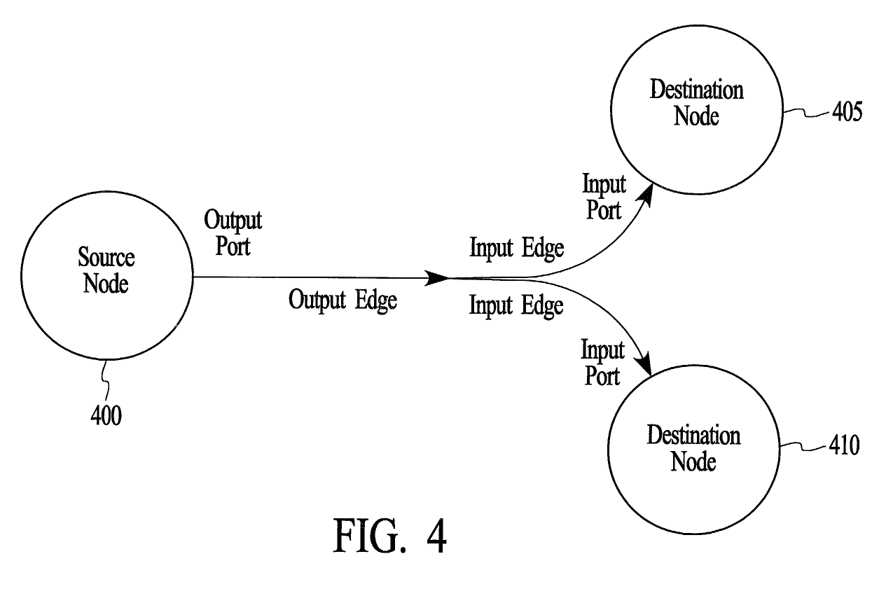

In accordance with the present invention, the code segments that form the programs to be processed are extracted and represented as dataflow graphs. A dataflow graph is formed by a set of nodes and edges. As shown in FIG. 4, a source node 400 may broadcast values to one or more destination nodes 405, 410, where each node executes an atomic operation, i.e., an operation that is supported by the underlying hardware as a single operation, e.g., an addition or shift. The operand(s) are output from the source node 400 from an output port along the path represented as edge 420, where edge 420 acts as an output edge of source node 400 and branches into input edges for destination nodes 405 and 410 to their input ports. From a logical point of view, a node takes zero time to execute. A node executes/fires when all of its input edges have values on them. A node without input edges is ready to execute at clock cycle zero.

Further, two types of edges can be represented in a dataflow graph. State edges are realized with a register, have a delay of one clock cycle, and may be used for constants and feedback paths. Wire edges have a delay of zero clock cycles, and have values that are valid only during the current clock cycle, thus forcing the destination node to execute on the same logical clock cycle as the source node. While dataflow graphs normally execute once and are never used again, a dataflow graph may be instantiated many times in order to execute a ‘for loop’. The state edges must be initialized before the ‘for loop’ starts, and the results may be ‘copied’ from the state edges when a ‘for loop’ completes. Some operations need to be serialized, such as input from a single data stream. The dataflow graph includes virtual boolean edges to force nodes to execute sequentially.

FIG. 3c illustrates the dataflow graph for the example program shown in FIG. 3b. In order to perform the operations represented by the dataflow graph, the graph is scheduled in time and assigned to hardware resources in space by a scheduler. Co-pending U.S. patent application Ser. No. ______ (Docket No. 2096P), filed May 31, 2001, entitled Method and System for Scheduling in an Adaptable Computing Engine and assigned to the assignee of the present invention, presents a preferred embodiment of a scheduler and its description is incorporated herein by reference. In general, the scheduler determines which nodes in the list of nodes specified by the input dataflow graph can be executed in parallel on a single clock cycle and which nodes must be delayed to subsequent cycles. The scheduler further assigns registers to hold intermediate values (as required by the delayed execution of nodes), to hold state variables, and to hold constants. In addition, the scheduler analyzes register life to determine when registers can be reused, allocates nodes to computation units, and schedules nodes to execute on specific clock cycles. Thus, for each node, there are several specifications, including: an operational code (Op Code), a pointer to the source code (e.g., firFilter.q, line 55); a pre-assigned computation unit, if any; a list of input edges; a list of output edges; and for each edge, a source node, a destination node, and a state flag, i.e., a flag that indicates whether the edge has an initial value.

Thus, as shown in FIG. 3d, for the example dataflow graph of FIG. 3c, three computation units are employed, where an input unit (IU) is assigned for inputting the ‘x’ value in a cycle 0, an arithmetic unit (AU) is assigned for adding the ‘x’ value to its output ‘y’ value in a cycle 1, and an output unit (OU) is assigned for outputting the resultant value in a cycle 3. Of course, the sequence of FIG. 3d illustrates a single instantiation of the graph. FIG. 3e illustrates the single instantiation of FIG. 3d concatentated with a second instantiation, while FIG. 3f illustrates the duplication of the graph needed for the example program where seven instantiations are needed (N=7). As represented in FIG. 3f, cycles 0 and 1 form a setup stage, cycles 2, 3, 4, 5, and 6 form a loop stage, and cycles 7 and 8 form a teardown stage, as is well understood in the art.

In a traditional parallel/pipelined arrangement of the computation units of the IU, AU and OU, the instructions being processed in each processing unit would be performed as represented in FIG. 3g. As shown, five instructions would be performed in parallel over 8 cycles. Under the example, the IU requires 16 bits per instruction, the AU requires 51 bits per instruction, and the OU requires 24 bits per instruction. Thus, the total number of bits needed to store these instructions for the example program is 455 bits.

Referring now to FIG. 3h, for each processing unit, a ‘X’ mark is shown to indicate when there is processing being performed by the computation unit, while the lack of the ‘X’ mark indicates a place where, traditionally, a NOP would be used. In accordance with the present invention, NOPs are avoided through the designation of each instruction as a combination of enable and action signals. The action signals are the actual instruction that an individual computation unit uses to determine what function to perform (e.g., multiplication, addition or subtraction). The action of a computation unit has no effect unless the results of the function execution are stored somewhere. In the preferred embodiment, the desired results are stored in a register or in a memory system where they can be used in subsequent computations or can be output from the system. Each of these storage operations requires an enable signal. Typically, the number of bits required to encode the action (e.g., the instruction) is much larger than the number of result bits produced by the execution of the instruction. Preferably, there is one write enable signal for each register or memory system. Whether the enable sate is encoded as a one or a zero is dependent on the design of the digital device. For the example situation, the 16 bits needed for the IU processing unit are split into a 1 bit enable signal and a 15 bit action signal, while for the AU processing unit, the 51 bits are split into a three bit enable signal and a 48 bit action signal, and for the OU, the 24 bits are split into a 2 bit enable signal and a 22 bit action signal.

In this manner, the five instructions that had been needed using traditional encoding of the VLIW are collapsed into a single instruction. Thus, as shown in FIG. 3i, each processing unit processes a single instruction equal in length to the number of bits of the action signal of its respective instruction when enabled according to the enable signal of the instruction. With 30 total bits used for the enable signals (see FIG. 3h) and 85 bits used for the action signals, there is a savings of about 340 bits of instruction memory for the example algorithm when processed with the instruction encoding in accordance with the present invention.

From the foregoing, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

What is claimed is:

1. A method for encoding instructions as a very long instruction word for processing in a plurality of computation units that reduces instruction memory requirements in a processing system, the method comprising the steps of:
(a) determining at which stages of instruction processing that an instruction code needs to be executed; and
(b) utilizing an enable signal of the instruction code to direct execution during the determined stages by enabling storage operations for the instruction code.

2. The method of claim 1 where the instruction code is associated with one of a plurality of computation units.

3. The method of claim 2 further comprising the step of (c) utilizing an action signal of the instruction code to execute each instruction when.

4. The method of claim 3 wherein utilizing an enable signal step (b) further comprises the step of (b1) encoding a chosen number of bits of the instruction code as the enable signal.

5. The method of claim 4 wherein the utilizing an action signal (c) further comprises the step (c1) encoding a remaining number of bits of the instruction code as the action signal.

6. The method of claim 3 wherein utilizing the enable signal and action signal for the instruction code avoids utilizing NOP (no operation) instruction codes in the very long instruction word.

7. A method for forming a very long instruction word in a processing system, the method comprising the steps of:
(a) encoding each instruction code of the very long instruction word as an enable signal and an action signal to collapse instruction fields in the very long instruction word; and
(b) associating each instruction code with a computation unit.

8. The method of claim 7 further comprising the step of (c) utilizing the enable signal to control storage operations when the action signal of each instruction is processed in the computation unit.

9. The method of claim 8 wherein the utilizing the enable signal (step c) occurs during each stage of processing.

10. The method of claim 9 wherein the utilizing the enable signal step (c) occurs during a loop stage of processing.

11. The method of claim 7 wherein the associating step (b) further comprises the step of (a1) associating based on a dataflow graph.

12. The method of claim 7 wherein the encoding step (a) further comprises the step of (a1) scheduling the very long instruction word for parallel processing.

13. A system for encoding instructions as a very long instruction word for processing that reduces instruction memory requirements in a processing system, the system comprising:
a plurality of computation units; and
a controller for controlling the plurality of computation units, wherein the controller determines at which stages of instruction processing that an instruction code needs to be executed and utilizes an enable signal of the instruction code to direct execution during the determined stages by enabling storage operations for the instruction code.

14. The system of claim 13 wherein the controller further utilizes an action signal of the instruction code for execution of each instruction in one of the plurality of computation units.

15. The system of claim 14 wherein the controller further encodes a chosen number of bits of the instruction code as the enable signal.

16. The system of claim 15 wherein the controller further encodes a remaining number of bits of the instruction code as the action signal.

17. The system of claim 13 further comprising an adapatable computing engine, the adaptable computing engine including the plurality of computation units and the controller.
